(19) United States
(12) Patent Application Publication
(10) Pub. No.: US 2008/0017509 A1
(43) Pub. Date: Jan. 24, 2008

(54) Chlorine Monitor and Recorder for Water Distribution Systems

(76) Inventor: Gary A. Brown, Kelowna (CA)

Correspondence Address: GARY ALAN BROWN, 4005 SANTA ANITA PL., KELOWNA, BC, V1W-2Z6, CA

(21) Appl. No.: 11/458,728

(22) Filed: Jul. 20, 2006

(51) Int. Cl. G01N 27/26

(52) U.S. Cl. 204/416; 324/425

(57) ABSTRACT

The invention proposed is an improved chlorine monitor providing advanced software technology to replace traditional costly electronic sensor interface boards. The device also provides capability for data logging and remote alarming and modem operation for downloading or assessing current conditions in real time. The device measures free residual chlorine to an accuracy of ±0.01 PPM [mg/l] by employing a long term gel based chlorine sensor with superior aging properties. The sensor aging is superior compared with the traditional wet-chemical based chlorine sensors that show declining readings as the traditional sensor wet-chemical storage volumes decline with usage.

### BACKGROUND

Chlorine monitoring in the water distribution industry generally concentrates on restricted numbers of locations in any city. Chief among these are the locations where chlorine injection to the water supply occurs. At this point the chlorine concentration is the highest distribution line concentration. Analytical equipment installed in these locations so health concerns can be evaluated and supported by monitoring facilities. These stations are expensive and contain a few drawbacks. First among them are the tendency to reduce the readings as the traditional chemical charge reagents customarily deplete in total quantity. A result is an ever increasing error in the measured values. Although this can be compensated for by using expensive electronic circuitry that tactic becomes a second drawback In large water distribution facilities because of the sheer cost of large numbers of units to cover the needs of complex and aging distribution systems cities where distribution lines are lengthy. Lengthy distribution lines lead to lengthy delivery times for clients of the water purveyor. This the residence time in the lines can and does often exceed 24 hours. As a result of this and the natural growing slime bacteria that inhabits the inner pipe surface the chlorine content in these remote locations may unknowingly fall well below health requirement standards and become a community health hazard.

### THE INVENTION

In general since monitoring for chlorine is a five thousand dollar per site cost, sites are kept to minimum as cited above. The invention described herein outlines a superior and more cost effective chlorine monitoring facility using a new chlorine electrode with a gel base of chemical electrode manufacture. Traditional chlorine monitors use wet-chemical additive solutions for the probes. As these chemicals exhaust the monitoring accuracy is usually shown to become suspect in accuracy.

The process of maintaining the liquid chemical sensor operable and accurate requires a considerable manpower. Installation often is only practical at locations where 115 VAC power and other amenities such as heated enclosure are available to support the monitoring process.

The preferred invention format for the said invention uses not only a gel based chlorine sensor of lengthy service history but also a low cost alarming data logger with modem facilities. The data logger will record readings at software settable intervals and supports remote download over the modem. The chlorine sensor, data logger and supporting cabling require a sample of water to be drawn continuously thus ensuring a superior monitoring strategy. The data logger will hold 5,220 readings with three probes, chlorine, pH and temperature. Downloading the conserved data prior to this allows superior records to be developed and maintained for both instantaneous and long term trouble shooting and service needs and health authority reviews.

A further improvement contributed to chlorine monitoring is the use of software to calibrate the chlorine electrode's readings. The inventor typically uses multi-term polynomial and other advanced equation types to interface sensors with data loggers. Without such groundbreaking the software sensors must be interfaced to reading apparatus by said interface electronic boards. These boards require careful engineering, their own temperature compensation and substantial electronic component sophistication to electronically ‘linearize’ the sensor signals obtained over the range of measurement from low readings to high readings regardless of impact by temperature and pH changes. In the invention described herein the software equations are themselves non-linear to compensate any non-linearity of the sensor to provide the accuracy required both in the industry and health authority requirements. Hence the interface boards mentioned, with their required accommodating electric power and enclosure space, are not required by the invention cited herein. Conventional systems require needed service for the conventional chlorine electrodes in the monitoring equipment using electronic calibration process and hence a substantial additional cost is created to maintain accurate water monitoring equipment through manpower and adjustment labor costs. The invention proposed herein uses the software to eliminate older technology thus presenting the industry with more comprehensive and cost effective monitoring of distribution system water chlorination levels.

The software operates in Windows in Microsoft Excel and the suitable sensor calibration equations are in the format of:

$${Chlorine}_{[ PPM ]} = {a}_{o} + {a}_{1} Cl + {a}_{2} {Cl}^{2} + {a}_{3} {Cl}^{3} + {a}_{4} {Cl}^{4} + {a}_{5} {Cl}^{5} … an n term polynomial example . \\ All of {a}_{o} , {a}_{1} , {a}_{2} , {a}_{3} , {a}_{4} , {a}_{5} … are specific constants .$$

Other equation formats that can calibrate any sensor using spline techniques [seamless shift to generate the correct output chlorine reading from one equation to another based upon the ‘y’ axis value at the moment] are:
Weibull
Richards
Logistic
MMF

For years municipalities have shown poor performance in monitoring residual chlorine in their water distribution systems. The need for a suitable chlorine monitor is substantial but the unit must have; alarm capability with pocket pager facility, memory logging and be sufficiently cost effective that the city or town can afford enough locations for the monitoring. Estimates are the city of New York may currently require a minimum over 5,000 units for this service. Preferred installation locations are the ‘end of the line’ points where the time between initial [or secondary] chlorine treatment and customer utilization may be unduly lengthy and thus is the major factor in creating a potential health hazard. This long residence time mentioned poses a danger to customers from common slime bacteria build-up inside pipes. The invention also focuses upon a suitably priced long lasting chlorine electrode which is simple to exchange due to the installation in the low pressure sampling train attached to the user distribution piping and includes the ability to compensate the chlorine readings for changes in temperature and pH as monitoring progresses if needed.

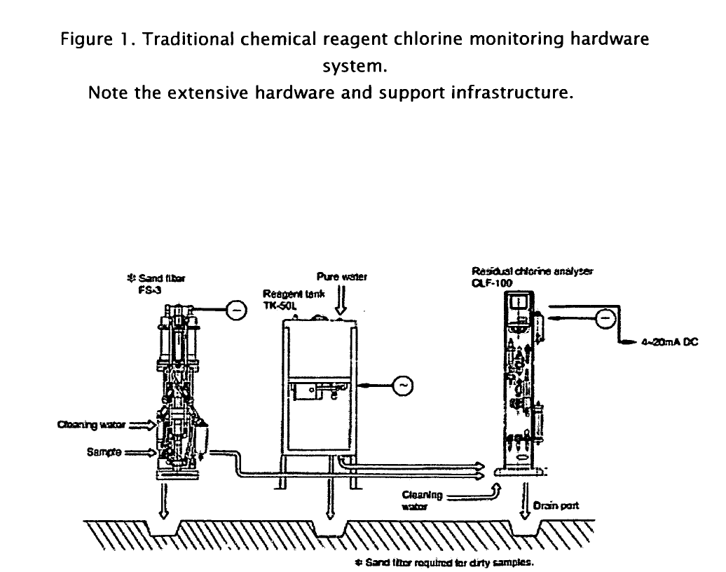

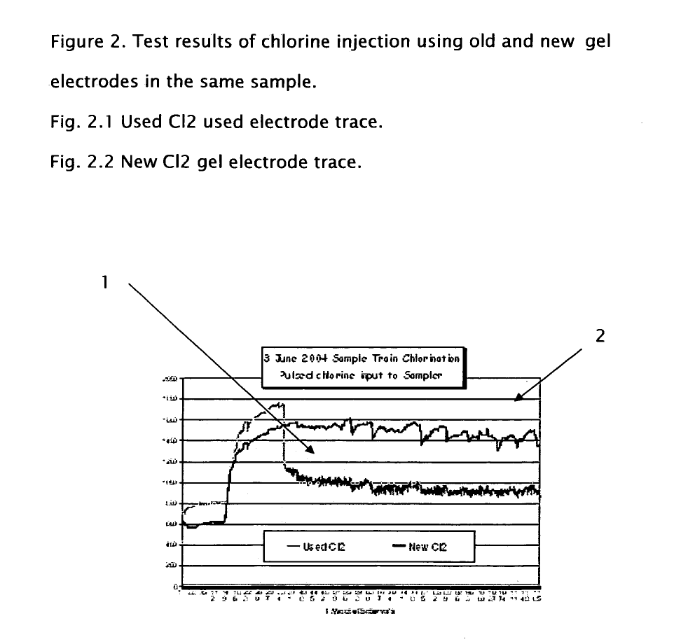

Test results of chlorine injection on gel electrodes in the same sample show excellent results See FIG. 2. A sensor that was ejected in prototype testing as unacceptable created the trace with the early high pulse.

Current public health concern is reflected in the following:

Assessment of the microbiological safety of drinking water
is based largely on the routine monitoring of water supplies for the
presence of total coliforms and Escherichia coli.
Detection of E. coli is considered indicative of recent
fecal contamination and of the potential presence of enteric
pathogens, while the presence of total coliforms is indicative of poor
water quality.

http://aem.asm.org/cgi/content/full/69/9/5463
Margaret M. Williams and Ellen B. Braun-Howland

Wadsworth Center, New York State Department of Health, Albany, New
York 12201

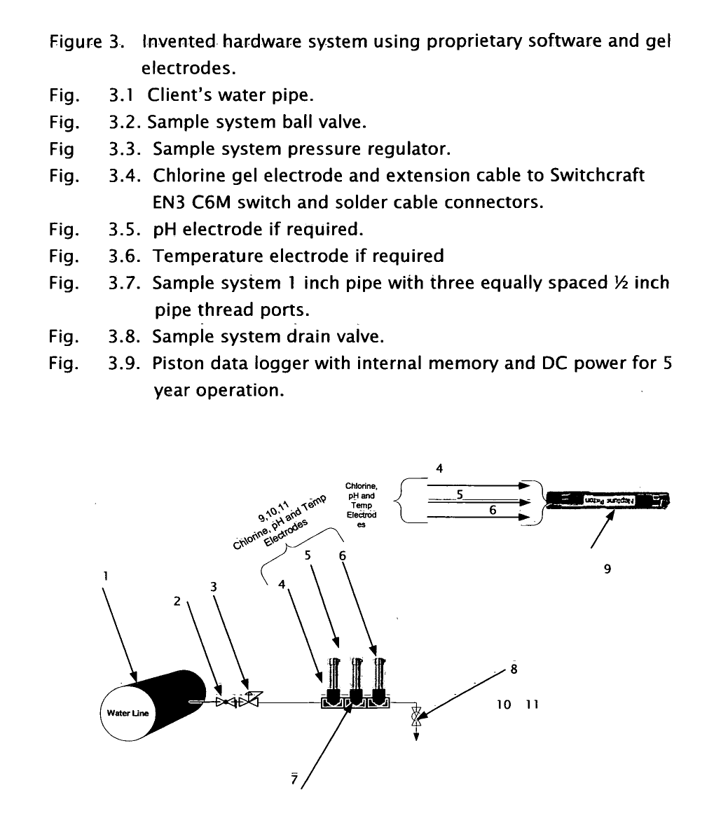

The invention system hardware herein that is suitable to combat this concern is shown in FIG. 3. This product features the application of the proprietary software cited previously. This software is initially tested to match newly installed chlorine sensor to precision laboratory free chlorine readings. This removes all concern that the system is inaccurate.

Manual samples may be taken at any time simply by measuring the chlorine content of the drain flow on the continuously running sampling system. Once installed in the system shown in FIG. 3 the entire collection of improved hardware allows both temperature and pH compensation of the chlorine readings if needed.

Included in the said chlorine monitoring and data logging system is the ability of the data logger to alarm and dial out on its discovery of low readings. Equally attractive is the ability to offer modem monitoring to station operating personnel from remote office locations over telephone lines. All of the data logger stored readings may be downloaded, the data logger reset and returned to operation takes but a few minutes once personnel become familiar with the operating software. All of the invention can be assembled and shipped for less than the cost of a single traditional chlorine monitoring analyzer without recording features. The traditional chlorine analyzer equipment fails to safeguard water distribution agencies against charges involving due diligence in potable water delivery unless provided with recording facilities. The invention herein incorporates data recording and real-time alarming as prime features of the said invented chlorine water monitoring process.

What is claimed is:

1. The chlorine sensor will allow resolution of free chlorine concentration to a minimum of 0.01 PPM or mg/L. The industry target concentration for customer delivery is 0.5 PPM or Mg/L.

2. The invention's chlorine measurement range is 0-2.0 PPM or mg/L.

3. The chlorine sensor will operate over a temperature range of 0-80 Deg C.

4. The chlorine sensor will operate despite water pressures up to 70 PSI, almost 500 Kpa.

5. The chlorines sensor is self-activated creating a millivolt output under normal circumstance of free chlorine in potable water.

6. The chlorine electrode connects by a quick connect assembly to the data logger analog input channels. UL approved Switchcraft 6 pin EN3C6M Threaded Connector is employed.

7. The data logger connects to a desktop or laptop using a standard RS232 cable connection. USB to RS232 converters are available.

8. The data logger is automatically poled when the cable is connected and the software is started and opens the invention supervisory screen.

9. The supervisory screen will allow download or ‘real time’ views.

10. System operators may observe the current conditions by leaving the logger connected to the sensors when opening the software and are provided with the said ‘real time’ screen display of the current conditions when requested.

11. The data logger may be connected to a modem using the same cited quick connection and replicate either of the said operations above for download or real time viewing.

12. The data logger analog input accommodates a compensating pH electrode suitable for a range of measurement of 4-9 pH units.

13. The proprietary software will accommodate correction of the readings for pH.

14. If necessary the proprietary software will also compensate for temperature.

15. The chlorine electrode is mounted in the sample train [see FIG. 3.]

16. The pH electrode is mounted in the sample train [see FIG. 3.]

17. The temperature electrode, if required is mounted in the sample train [see FIG. 3.]

18. The sample train consists of a simple ½ or ¾ inch stainless steel ball valve, a pressure regulator and a ½ inch needle valve and a sample train horizontal pipe with ½ inch thread holes for mounting each of chlorine, pH and temperature electrodes. The outlet measured sample is sent to a drain. Flow is set at a continuous slow rate by the needle valve installed after the sample train and adjusted by the operators so pipe or tank pressure drives the flow at a slow but continuous rate.

19. The chlorine electrode readings are calibrated by the cited multi-term polynomial or other curve fitting equation to the accuracy in claim 1. above.

20. Components are interchangeable. A new data logger may be inserted in the system in minutes. New sensors simply require stoppage of sample water flow and re-installation of new sensor(s).

21. The system will operate on its own battery and sensor outputs if modem or telephone facilities are required they will additionally require conventional 115 Volt AC power.

22. In cases of station power failure the system will continue to collect and save he needed data as the data logger battery has a 5-year lifetime.
